(19) United States
(12) Patent Application Publication
(10) Pub. No.: US 2011/0051092 A1
(43) Pub. Date: Mar. 3, 2011

(54) OPTICAL ELEMENT, OPTICAL UNIT, AND PROJECTION DISPLAY APPARATUS FOR SWITCHING POLARIZATION DIRECTION

(75) Inventor: Ken Mashitani, Hirakata-City (JP)

(73) Assignee: SANYO ELECTRIC CO., LTD, Moriguchi-shi (JP)

(21) Appl. No.: 12/869,178

(22) Filed: Aug. 26, 2010

(30) Foreign Application Priority Data
Aug. 26, 2009 (JP) 2009-195470

(51) Int. Cl. G02B 27/26; G02B 27/28; G02B 5/30

(52) U.S. Cl. 353/8; 359/484; 359/486

(57) ABSTRACT

Each of a first polarization separation element and a second polarization separation element reflects one of two polarization components perpendicular to each other included in incident light and transmits the other polarization component. A switching element is placed between the first polarization separation element and second polarization separation element and switches between a first state of transmitting an incident polarization component as it is and a second state of converting an incident polarization component to the other polarization component perpendicular to the incident polarization component and transmitting the converted component.

This application is based upon and claims the benefit of priority from the prior Japanese Patent Application No. 2009-195470, filed Aug. 26, 2009, the entire contents of which are incorporated herein by reference.

### BACKGROUND OF THE INVENTION

1. Field of the Invention

The present invention relates to an optical element, an optical unit, and a projection display apparatus for switching the polarization direction.

2. Description of the Related Art

There have been developed projection display apparatuses (hereinafter, also referred to as projectors, as needed) having both the function to project normal images (hereinafter, referred to as two-dimensional images) on a projection surface and the function to project parallax images on a projection surface so as to provide stereoscopic images (hereinafter, referred to as three-dimensional images) to a viewer. A polarized glasses method is one of methods for showing three-dimensional images to viewers. Polarized glasses provide filtering on incident light so that polarization components perpendicular to each other (such as P-polarized light and S-polarized light) or circularly polarized light components of which the directions of rotation are opposite to each other (such as right-handed circularly polarized light and left-handed circularly polarized light) enter the right eye and left eye of a viewer, respectively.

There have been proposed various methods for projector systems employing such a polarized glasses method. For example, there is proposed a method (first method) in which two projectors, a first projector for projecting images for the right eye and a second projector for projecting images for the left eye, are prepared, and a polarizing plate for transmitting a polarization component for the right eye is placed posterior to the projection lens of the first projector (more specifically, in the path of light emitted from the projection lens), and a polarizing plate for transmitting a polarization component for the left eye is placed posterior to the projection lens of the second projector.

There is also proposed a method (second method) in which one projector, which projects images for the right eye and left eye by switching the images in a time-division manner, is used and a polarization switcher is placed posterior to the projection lens of the projector. The polarization switcher includes a polarizing plate and a liquid crystal element for switching the polarization direction according to a voltage applied to the element.

Further, there is proposed a method (third method) for switching the color component or polarization direction in a time-division manner by rotating a color wheel onto which polarizing elements are attached.

The first method described above requires two projectors. Also, in the first and second methods above, although an existing projector for two-dimensional images can be easily diverted to a projector for three-dimensional images, since a polarizing plate or polarization switcher is provided posterior to the projection lens, a larger size of the polarizing plate or polarization switcher is required.

In the third method described above, polarizing elements can be miniaturized. However, in a projector according to the third method, since non-polarized light emitted from a light source passes through the polarizing elements attached onto the color wheel even when a two-dimensional image is projected, the amount of light for projecting a two-dimensional image is reduced. More specifically, the light amount is reduced to half the intrinsic amount of light for projecting a two-dimensional image. The light amount will be reduced in the same way also in the first and second methods if the polarizing plate or polarization switcher posterior to the projection lens is not removed, but such reduction of light amount can be prevented by removing the polarizing plate or polarization switcher.

There can be considered a method in which polarizing elements are not integrated with the color wheel as described in the third method but are independently provided within the projector. In a projector according to such a method, however, the polarizing elements need be removed from the light path in order to prevent the reduction of the amount of light for projecting a two-dimensional image, and a mechanism therefor is also necessary.

### SUMMARY OF THE INVENTION

An optical unit of one embodiment of the present invention comprises: a first polarization separation element and a second polarization separation element which each are configured to reflect one of two polarization components perpendicular to each other included in incident light and transmit the other polarization component; and a switching element placed between the first polarization separation element and the second polarization separation element and configured to be switchable between a first state of transmitting an incident polarization component as it is and a second state of converting an incident polarization component to the other polarization component perpendicular thereto and transmitting the converted component.

Another embodiment of the present invention is a projection display apparatus. The apparatus comprises: the optical unit state above; and a control unit configured to switch between a two-dimensional mode for displaying a two-dimensional image and a three-dimensional mode for displaying a three-dimensional image. The control unit provides control such that the switching element is placed in the first state or the second state in accordance with switching between the two-dimensional mode and the three-dimensional mode.

Yet another embodiment of the present invention is an optical element. The optical element is of wire grid type and includes metal wires and half-wave plates inserted between the metal wires.

Still yet another embodiment of the present invention is an optical unit. The optical unit comprises the optical element state above, a quarter-wave plate provided posterior to the optical element, and a reflecting plate provided posterior to the quarter-wave plate.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram that shows a configuration of a projection display apparatus according to an embodiment 1 of the present invention;

FIG. 2 are diagrams that show a configuration of a reflecting optical unit according to an embodiment 2, in which FIG. 2A shows a state in a three-dimensional mode while FIG. 2B shows a state in a two-dimensional mode;

FIG. 3 is a schematic diagram that shows a configuration of a projection display apparatus according to a modification 1 of the embodiment 1 of the present invention;

FIG. 4 are diagrams that show a configuration of a reflecting optical unit according to a modification 1 of the embodiment 2, in which FIG. 4A shows a state 1 in the three-dimensional mode while FIG. 4B shows a state 2 in the three-dimensional mode;

FIG. 5 are diagrams that show a configuration of a reflecting optical unit according to a modification 2 of the embodiment 2, in which FIG. 5A shows a state 1 in the three-dimensional mode while FIG. 5B shows a state 2 in the three-dimensional mode;

FIG. 6 are diagrams that show a configuration of a reflecting optical unit according to a modification 3 of the embodiment 2, in which FIG. 6A shows a state 1 in the three-dimensional mode while FIG. 6B shows a state 2 in the three-dimensional mode;

FIG. 7 is a diagram that shows a configuration of a reflecting optical unit according to a modification 4 of the embodiment 2;

FIG. 8 are diagrams that show configurations of reflecting optical units according to a modification 5 of the embodiment 2, in which FIG. 8A shows an example in which the second polarization separation element 73 is configured to be a convex while FIG. 8B shows the configuration as shown in FIG. 2;

FIG. 9 is a diagram that shows a configuration of an optical element according to an embodiment 3;

FIG. 10 is a diagram that shows a configuration of an optical unit according to an embodiment 4; and

FIG. 11 is a diagram that shows a configuration of an optical unit according to an embodiment 5.

### DETAILED DESCRIPTION OF THE INVENTION

The invention will now be described by reference to the preferred embodiments. This does not intend to limit the scope of the present invention, but to exemplify the invention.

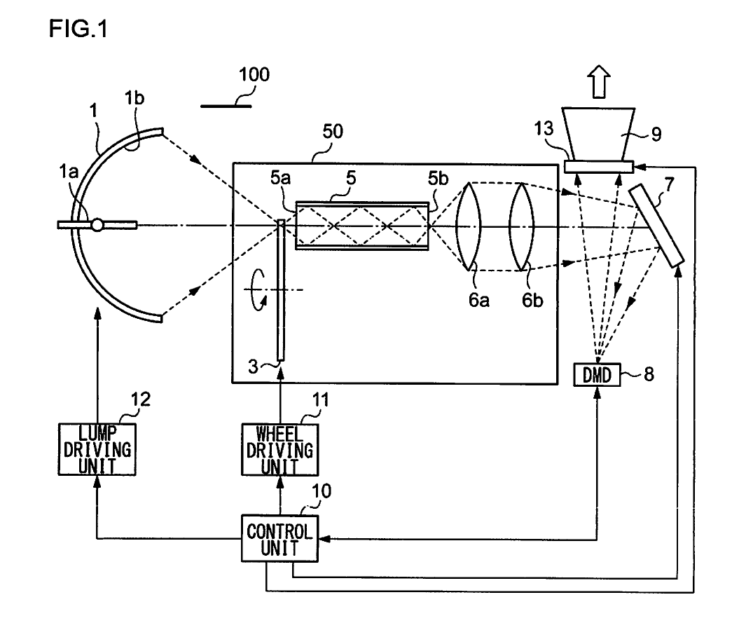

FIG. 1 is a schematic diagram that shows a configuration of a projection display apparatus 100 according to an embodiment 1 of the present invention. The projection display apparatus 100 is capable of projecting a two-dimensional image on a projection surface, such as a screen, to display the image (hereinafter, such usage is referred to as a two-dimensional mode) and also capable of projecting a parallax image on a projection surface to display a three-dimensional image (or to allow a viewer to sense a three-dimensional image, more strictly) (hereinafter, such usage is referred to as a three-dimensional mode).

A light source 1 provides light to an optical unit 50 under the control of a lump driving unit 12. For the light source 1, a halogen lamp having the electrode configuration with a filament, a lamp having the electrode configuration of generating arc discharge, such as a metal halide lamp, xenon short arc lamp, and high-pressure mercury lamp, or an LED lamp may be used. Light emitted from a luminous tube 1a provided in the center part of the light source 1 is collected by a reflector 1b having an elliptical surface or a hyperboloid, so as to be provided to the optical unit 50.

The optical unit 50 includes a color wheel 3, a rod integrator 5, and condenser lenses 6a and 6b. Light emitted from the light source 1 passes through the color wheel 3, rod integrator 5, and condenser lenses 6a and 6b in this order. The color wheel 3 is discoid in shape and provided perpendicular to the optical axis of light emitted from the light source 1. The color wheel 3 rotates about a rotation axis parallel to the optical axis under the control of a wheel driving unit 11.

More specifically, the color wheel 3 has a surface facing incident light, on which are formed an R region for transmitting the red component of incident light, a G region for transmitting the green component of incident light, and a B region for transmitting the blue component of incident light. As it rotates, the color wheel 3 sequentially transmits red light, green light, and blue light in a time-division manner. There may be further formed on the surface facing incident light a W region for transmitting all the color components of incident light in addition to the R, G, and B regions. Also, there may be formed a Cy region, a Ye region, and an Mg region for transmitting complimentary colors of cyan, yellow, and magenta, for example.

The rod integrator 5 is provided on the optical axis mentioned above posterior to the color wheel 3. The rod integrator 5 equalizes the illuminance of light incident from the entrance face 5a and allows the light to outgo from the exit face 5b.

The condenser lenses 6a and 6b are arranged on the aforementioned optical axis so as to face the exit face 5b of the rod integrator 5. The condenser lenses 6a and 6b collect light from the exit face 5b of the rod integrator 5 and provide the light to a reflecting optical unit 7.

The reflecting optical unit 7 is arranged on the aforementioned optical axis so as to have a certain inclination relative to the optical axis. The reflecting optical unit 7 reflects light from the condenser lenses 6a and 6b to provide the light to a imager 8. The reflecting optical unit 7 has a function to switch the mode between the two-dimensional mode and three-dimensional mode according to an instruction from a control unit 10. The reflecting optical unit 7 will be detailed later.

The imager 8 modulates light reflected by the reflecting optical unit 7 according to an image signal specified by the control unit 10 and provides the light thus modulated to a time-division polarization switching element 13. There is shown an example in which a DMD (Digital Micromirror Device) is used. A DMD includes multiple micromirrors relative to the number of pixels and generates a desired image by having the direction of each micromirror controlled according to each pixel signal.

The time-division polarization switching element 13 is placed between the imager 8 and a projection lens 9. In the present embodiment, the time-division polarization switching element 13 is provided directly on the entrance of the projection lens 9 or with a certain space in between. In the three-dimensional mode, the time-division polarization switching element 13 switches the polarization direction of light modulated by the imager 8 between two polarization directions perpendicular to each other in a time-division manner, according to an instruction from the control unit 10. The time-division polarization switching element 13 will be detailed later.

The projection lens 9 projects light modulated by the imager 8 onto a screen or another projection surface, which is not illustrated. Since the projection lens 9 forms an image from the light modulated by the imager 8, the image generated by the imager 8 is enlarged and displayed on the projection surface. In the three-dimensional mode, the polarization direction of light incident on the projection lens 9 is switched by the time-division polarization switching element 13 in a time-division manner.

The control unit 10 controls the lump driving unit 12, wheel driving unit 11, reflecting optical unit 7, imager 8, and time-division polarization switching element 13. More specifically, the control unit 10 provides an on/off signal to the lump driving unit 12 so as to allow the lump driving unit 12 to turn on or off the power of the light source 1. The control unit 10 also provides a rotation control signal to the wheel driving unit 11 so as to allow the wheel driving unit 11 to rotate the color wheel 3. Further, the control unit 10 provides an image signal to the imager 8 so as to allow the imager 8 to generate a desirable image.

The control unit 10 also provides a mode switching signal to the reflecting optical unit 7 so as to allow the reflecting optical unit 7 to switch the mode between the two-dimensional mode and three-dimensional mode. This mode switching process will be detailed later. The control unit 10 provides a polarization switching signal to the time-division polarization switching element 13 in the three-dimensional mode to allow the time-division polarization switching element 13 to switch the polarization direction in a time-division manner. In the two-dimensional mode, since the polarization direction need not be fixed, there is no need to allow the time-division polarization switching element 13 to switch the polarization direction in a time-division manner.

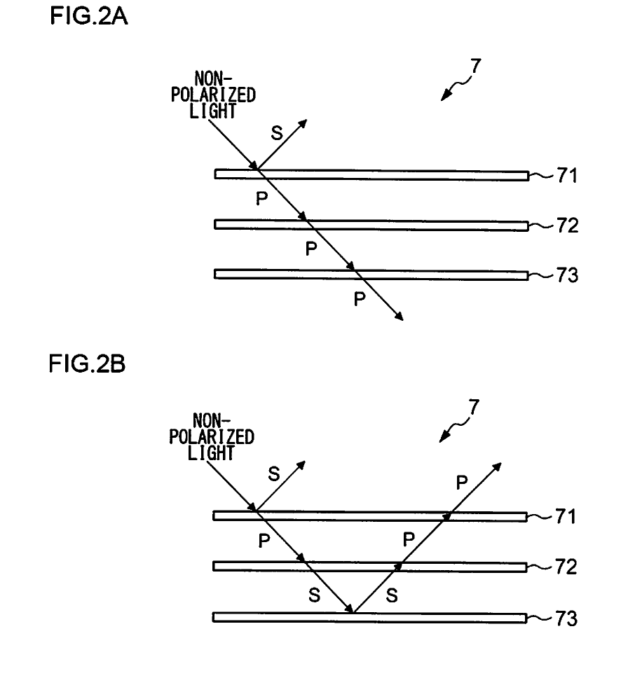

FIG. 2 are diagrams that show a configuration of a reflecting optical unit according to the embodiment 2: FIG. 2A shows a state in the three-dimensional mode while FIG. 2B shows a state in the two-dimensional mode. The reflecting optical unit according to the embodiment 2 is an optical element suitable for the reflecting optical unit 7 in the projection display apparatus 100 according to the embodiment 1. In the following, description is given on the premise that the reflecting optical unit 7 according to the embodiment 2 is provided in the projection display apparatus 100 according to the embodiment 1.

The reflecting optical unit 7 according to the embodiment 2 comprises a first polarization separation element 71, a switching element 72, and a second polarization separation element 73. Each of the first polarization separation element 71 and second polarization separation element 73 reflects one of two polarization components perpendicular to each other (such as P-polarized light and S-polarized light) included in incident light and transmits the other polarization component. The switching element 72 is placed between the first polarization separation element 71 and second polarization separation element 73 and is switchable between a first state of transmitting an incident polarization component as it is and a second state of converting an incident polarization component to the other polarization component perpendicular thereto and transmitting the converted component.

In the reflecting optical unit 7, the second polarization separation element 73, switching element 72, and first polarization separation element 71 may be laminated in this order and integrally formed. The second polarization separation element 73 and switching element 72 may be in contact with each other, or there may be provided a space in between. The relationship between the switching element 72 and first polarization separation element 71 is also the same.

The first polarization separation element 71 is a layer for receiving non-polarized incident light. The first polarization separation element 71 reflects a first polarized light, which is either S-polarized light perpendicular to the plane of incidence or P-polarized light parallel with the plane of incidence included in non-polarized incident light, and transmits a second polarized light, which is the other polarized light.

For the first polarization separation element 71, a wire grid can be used. A wire grid is a non-absorbing polarizing plate prepared by evaporating metal material (such as aluminum) onto a glass substrate and forming wire-like grid by fine etching at the nanometric level. Generally, a wire grid reflects S-polarized light and transmits P-polarized light in incident light. By changing the direction of ribs forming a grid, another type of wire grid, which reflects P-polarized light and transmits S-polarized light in incident light, can be also obtained. Besides a wire grid, a dielectric multilayer film with a polarization separation coating applied thereto may be also used for the first polarization separation element 71.

In the following, there will be described an example using the first polarization separation element 71 that reflects S-polarized light and transmits P-polarized light in incident light. With regard to the case of using the first polarization separation element 71 that reflects P-polarized light and transmits S-polarized light in incident light, the following description is also applicable by interchanging P-polarized light and S-polarized light therein.

The switching element 72 is switchable between a first state of transmitting P-polarized light provided from the first polarization separation element 71 as it is and a second state of converting P-polarized light provided from the first polarization separation element 71 to S-polarized light and transmitting the converted light.

For the switching element 72, a liquid crystal element that changes its state according to whether or not a voltage is applied thereto can be used. The liquid crystal element changes the orientation of liquid crystal molecules according to the voltage. When no voltage is applied, the liquid crystal element behaves as a half-wave plate (also called a λ/2 phase plate) (this state corresponds to the second state set forth above). A half-wave plate gives the phase difference of 180 degrees to perpendicular components of incident light, thereby rotating linearly polarized light. The rotation angle is adjustable with the angle between the incident polarized light and the slow axis, and, when linearly polarized light makes a 45-degree angle with the slow axis, the plane of the linearly polarized light rotates by 90 degrees. Namely, S-polarized light can be converted to P-polarized light, and vice versa.

When voltage is applied, the liquid crystal element behaves as a simple transmission plate that gives no phase difference to perpendicular components of incident light (this state corresponds to the first state set forth above). Accordingly, incident light passes through the plate as it is, i.e., when S-polarized light comes in, the S-polarized light passes through the plate as it is, and, when P-polarized light comes in, the P-polarized light passes through the plate as it is.

The second polarization separation element 73 reflects S-polarized light and transmits P-polarized light provided from the switching element 72. The second polarization separation element 73 can be configured in the same way as the first polarization separation element 71.

The control unit 10 applies a voltage to the switching element 72 in the three-dimensional mode so as to provide control such that the switching element 72 is placed in the first state (see FIG. 2A), while the control unit 10 applies no voltage to the switching element 72 in the two-dimensional mode so as to provide control such that the switching element 72 is placed in the second state (see FIG. 2B).

As shown in FIG. 2A, the switching element 72 behaves as a simple transmission plate in the three-dimensional mode, so that the switching element 72 transmits P-polarized light provided from the first polarization separation element 71 as it is. The second polarization separation element 73 then also transmits the P-polarized light provided from the switching element 72. Thus, in the three-dimensional mode, the whole reflecting optical unit 7 functions as a polarization separation element that reflects S-polarized light and transmits P-polarized light.

On the other hand, as shown in FIG. 2B, the switching element 72 behaves as a half-wave plate in the two-dimensional mode, so that the switching element 72 convert P-polarized light provided from the first polarization separation element 71 to S-polarized light and transmits the converted light. The second polarization separation element 73 then reflects the S-polarized light provided from the switching element 72. The switching element 72 then converts the S-polarized light provided from the second polarization separation element 73 to P-polarized light and transmits the converted light. Thereafter, the first polarization separation element 71 transmits the P-polarized light provided from the switching element 72. Thus, in the two-dimensional mode, the whole reflecting optical unit 7 functions as a mirror that reflects both S-polarized light and P-polarized light.

For the time-division polarization switching element 13 shown in FIG. 1, the aforementioned liquid crystal element can be used similarly to the switching element 72. In the three-dimensional mode, the control unit 10 switches, in a time-division manner, between the state in which a voltage is applied to the time-division polarization switching element 13 and the state in which no voltage is applied to the element 13. In the two-dimensional mode, since the polarization direction need not be fixed, such switching in a time-division manner is not required and the state is fixed to either state. In terms of power consumption, it is preferable to fix the state to the no-voltage applied state.

The time-division polarization switching element 13 behaves as a half-wave plate when no voltage is applied thereto, so that the element 13 converts S-polarized light provided from the reflecting optical unit 7 via the imager 8 to P-polarized light and transmits the converted light. On the other hand, the time-division polarization switching element 13 behaves as a simple transmission plate when a voltage is applied thereto, so that the element 13 transmits S-polarized light provided from the reflecting optical unit 7 via the imager 8 as it is. Accordingly, parallax image light to be provided to each of the right eye and left eye of a viewer wearing polarized glasses can be provided as an appropriate polarization component.

The time-division polarization switching element 13 may include a quarter-wave plate (also called a λ/4 phase plate) in addition to the aforementioned liquid crystal element. A quarter-wave plate gives the phase difference of 90 degrees to perpendicular components of incident light, thereby converting linearly polarized light to circularly polarized light, and vice versa. When linearly polarized light makes a 45-degree angle with the slow axis, the linearly polarized light is converted to circularly polarized light. For example, S-polarized light is converted to right-handed circularly polarized light, while P-polarized light is converted to left-handed circularly polarized light. Conversely, S-polarized light may be converted to left-handed circularly polarized light, while P-polarized light is converted to right-handed circularly polarized light.

In this way, by adding a quarter-wave plate to the time-division polarization switching element 13, the element 13 can provide right-handed circularly polarized light and left-handed circularly polarized light in a time-division manner, thereby also handling the case of circularly polarized glasses. In comparison with linearly polarized glasses, circularly polarized glasses have a feature of keeping crosstalk between left and right images low even when the viewer wearing the glasses faces another direction.

The liquid crystal element and the quarter-wave plate may be placed in this order or may be placed in the reverse order.

Thus, according to the embodiments 1 and 2, the reflecting optical unit 7 is configured to have the switching element 72, which is capable of behaving as both a half-wave plate and a simple transmission plate, between the first polarization separation element 71 and second polarization separation element 73, thereby switching between non-polarization state and polarization state with such a simple configuration while preventing the reduction of light amount.

More specifically, it is only necessary to place, within an existing projection display apparatus 100, the reflecting optical unit 7 according to the embodiment 2 instead of a reflecting mirror at the position where the reflecting mirror has been placed and add the time-division polarization switching element 13. The configurations of the components to be added and provided as a replacement are simple because these are all small parts and electrically controlled. Since all polarization components can be reflected in the two-dimensional mode, an almost normal amount of light can be maintained also in the two-dimensional mode. If the reflecting optical unit 7 is configured only with the first polarization separation element 71, the light amount will be reduced by half because P-polarized light is not reflected.

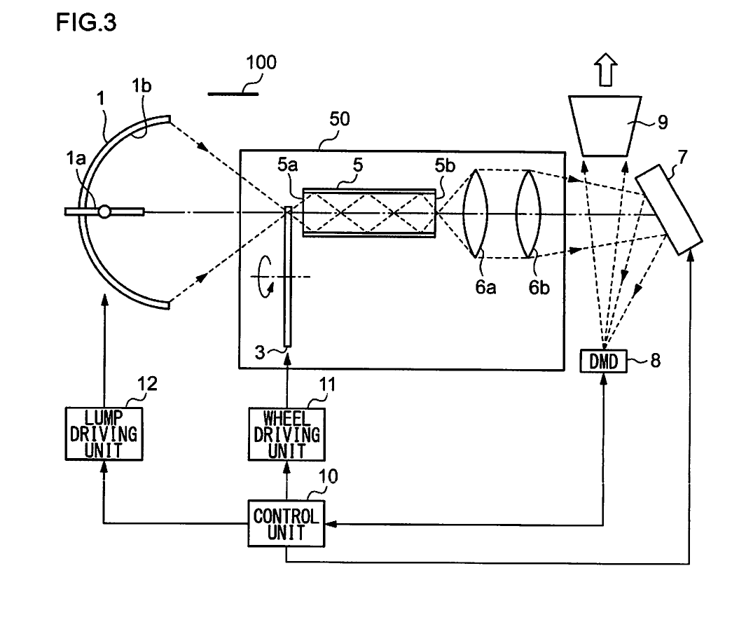

FIG. 3 is a schematic diagram that shows a configuration of the projection display apparatus 100 according to a modification 1 of the embodiment 1 of the present invention. In comparison with the projection display apparatus 100 shown in FIG. 1, in the projection display apparatus 100 according to the modification 1, the time-division polarization switching element 13 is provided as a constituting element of the reflecting optical unit 7 and integrally configured therein, instead of being placed at the entrance of the projection lens 9. Since the operation of each constituting element of the projection display apparatus 100 according to the modification 1 is identical with that of the projection display apparatus 100 shown in FIG. 1, the description thereof is omitted here.

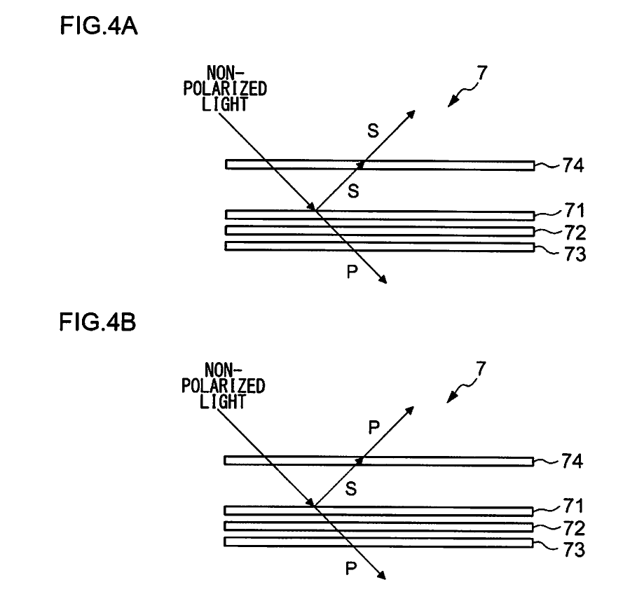

FIG. 4 are diagrams that show a configuration of a reflecting optical unit according to a modification 1 of the embodiment 2: FIG. 4A shows a state 1 in the three-dimensional mode while FIG. 4B shows a state 2 in the three-dimensional mode. The reflecting optical unit according to the modification 1 of the embodiment 2 is an optical element suitable for the reflecting optical unit 7 in the projection display apparatus 100 according to the modification 1 of the embodiment 1. In the following, description is given on the premise that the reflecting optical unit 7 according to the modification 1 of the embodiment 2 is provided in the projection display apparatus 100 according to the modification 1 of the embodiment 1. The same premise will be given also in the case of the reflecting optical units 7 according to modifications 2 and 3 of the embodiment 2 described later.

The reflecting optical unit 7 according to the modification 1 of the embodiment 2 comprises the first polarization separation element 71, switching element 72 (given as a mode switching element 72 in the modifications 1-3 of the embodiment 2), second polarization separation element 73, and a time-division polarization switching element 74. In the reflecting optical unit 7, the second polarization separation element 73, mode switching element 72, first polarization separation element 71, and time-division polarization switching element 74 are laminated in this order and integrally formed.

As with the time-division polarization switching element 13 discussed previously, the time-division polarization switching element 74 behaves as a simple transmission plate when a voltage is applied thereto (see FIG. 4A), so that the element 74 transmits S-polarized light provided from the first polarization separation element 71 as it is. On the other hand, the time-division polarization switching element 74 behaves as a half-wave plate when no voltage is applied thereto (see FIG. 4B), so that the element 74 converts S-polarized light provided from the first polarization separation element 71 to P-polarized light and transmits the converted light.

Since it does not act on non-polarized light, the time-division polarization switching element 74 has no influence on light provided from the condenser lenses 6a and 6b or light provided from the first polarization separation element 71 in the two-dimensional mode. It is because such light is not polarized.

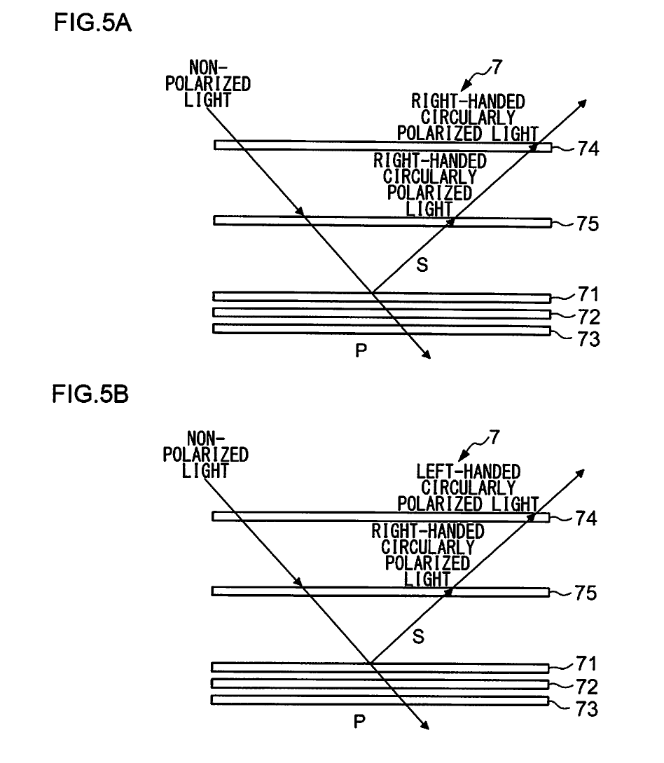

FIG. 5 are diagrams that show a configuration of a reflecting optical unit according to a modification 2 of the embodiment 2: FIG. 5A shows a state 1 in the three-dimensional mode while FIG. 5B shows a state 2 in the three-dimensional mode.

The reflecting optical unit 7 according to the modification 2 of the embodiment 2 comprises the first polarization separation element 71, mode switching element 72, second polarization separation element 73, time-division polarization switching element 74, and a quarter-wave plate 75. In the reflecting optical unit 7, the second polarization separation element 73, mode switching element 72, first polarization separation element 71, quarter-wave plate 75, and time-division polarization switching element 74 are laminated in this order and integrally formed. Namely, the reflecting optical unit 7 according to the modification 2 has a configuration in which the quarter-wave plate 75 is added between the first polarization separation element 71 and time-division polarization switching element 74 in the reflecting optical unit 7 according to the modification 1 described previously.

In the three-dimensional mode, the quarter-wave plate 75 converts S-polarized light reflected by the first polarization separation element 71 to right-handed circularly polarized light. Since it does not act on non-polarized light, the quarter-wave plate 75 does not act in the two-dimensional mode.

As with the time-division polarization switching element 13 discussed previously, the time-division polarization switching element 74 behaves as a simple transmission plate when a voltage is applied thereto (see FIG. 5A), so that the element 74 transmits the right-handed circularly polarized light provided from the quarter-wave plate 75 as it is. On the other hand, the time-division polarization switching element 74 behaves as a half-wave plate when no voltage is applied thereto (see FIG. 5B), so that the element 74 converts the right-handed circularly polarized light provided from the quarter-wave plate 75 to left-handed circularly polarized light and transmits the converted light.

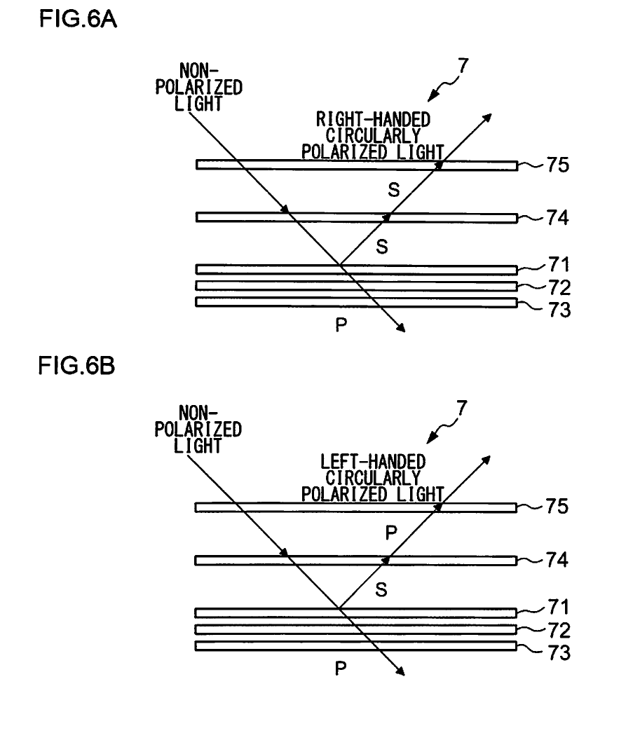

FIG. 6 are diagrams that show a configuration of a reflecting optical unit according to a modification 3 of the embodiment 2: FIG. 6A shows a state 1 in the three-dimensional mode while FIG. 6B shows a state 2 in the three-dimensional mode.

The reflecting optical unit 7 according to the modification 3 of the embodiment 2 comprises the first polarization separation element 71, mode switching element 72, second polarization separation element 73, time-division polarization switching element 74, and quarter-wave plate 75. In the reflecting optical unit 7, the second polarization separation element 73, mode switching element 72, first polarization separation element 71, time-division polarization switching element 74, and quarter-wave plate 75 are laminated in this order and integrally formed. Namely, the reflecting optical unit 7 according to the modification 3 has a configuration in which the time-division polarization switching element 74 and quarter-wave plate 75 are interchanged in the reflecting optical unit 7 according to the modification 2 described previously.

As with the time-division polarization switching element 13 discussed previously, the time-division polarization switching element 74 behaves as a simple transmission plate when a voltage is applied thereto (see FIG. 6A), so that the element 74 transmits S-polarized light provided from the first polarization separation element 71 as it is. The quarter-wave plate 75 then converts the S-polarized light provided from the time-division polarization switching element 74 to right-handed circularly polarized light. On the other hand, the time-division polarization switching element 74 behaves as a half-wave plate when no voltage is applied thereto (see FIG. 6B), so that the element 74 converts S-polarized light provided from the first polarization separation element 71 to P-polarized light and transmits the converted light. In this case, the quarter-wave plate 75 converts the P-polarized light provided from the time-division polarization switching element 74 to left-handed circularly polarized light.

Thus, the modification 1 of the embodiment 1 and the modifications 1-3 of the embodiment 2 provide effects similar to those provided by the basic example of the embodiment 1 and 2 shown in FIGS. 1 and 2. A designer may employ any of the configuration shown in FIG. 2 (based on FIG. 1) and the configurations shown in FIGS. 4-6 (based on FIG. 3) in consideration of cost or restriction caused by the configurations other than the reflecting optical unit 7 and time-division polarization switching element 13 (or time-division polarization switching element 74).

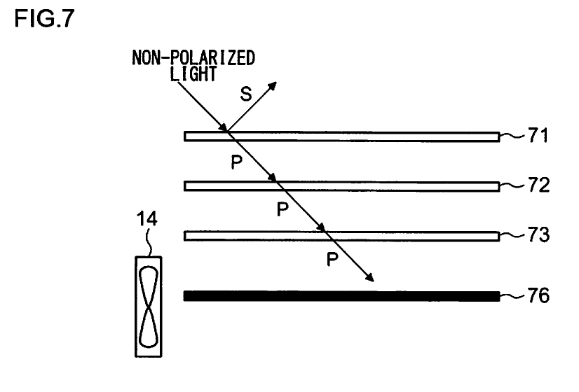

FIG. 7 is a diagram that shows a configuration of a reflecting optical unit according to a modification 4 of the embodiment 2. The reflecting optical unit according to the modification 4 of the embodiment 2 has a configuration in which an absorbing plate 76 is added to the reflecting optical unit 7 according to the basic example of the embodiment 2 shown in FIG. 2. In the reflecting optical unit 7 according to the modification 4, the absorbing plate 76, second polarization separation element 73, switching element 72, and first polarization separation element 71 are laminated in this order and integrally formed.

For the absorbing plate 76, a metal plate with black paint applied thereto can be used. In the three-dimensional mode, the second polarization separation element 73 transmits P-polarized light. The absorbing plate 76 then absorbs the P-polarized light.

In the modification 4, there may be provided a cooling means for cooling the absorbing plate 76 within the projection display apparatus 100. For example, a fan 14 may be provided. The control unit 10 allows the fan 14 to rotate so as to cool the absorbing plate 76 in the three-dimensional mode. In the two-dimensional mode, since the second polarization separation element 73 does not transmit P-polarized light (or S-polarized light, obviously) and no light is provided from the second polarization separation element 73 to the absorbing plate 76, the necessity to cool the absorbing plate 76 is low. Accordingly, the control unit 10 may stop the fan 14 in the two-dimensional mode.

The absorbing plate 76 may not necessarily be integrally configured in the reflecting optical unit 7 and may be placed at any position in the path of light provided from the second polarization separation element 73. Also, a polarizing plate that absorbs P-polarized light may be used instead of the absorbing plate 76. Further, a cooling means of contact type, such as a Peltier device, may be used instead of the fan 14. The absorbing plate 76 and fan 14 according to the modification 4 are also applicable to the reflecting optical unit 7 according to each of the modifications 1-3 of the embodiment 2.

Thus, according to the modification 4 of the embodiment 2, the absorbing plate 76 prevents P-polarized light that has passed through the second polarization separation element 73 from being diffusely reflected within the projection display apparatus 100 and entering the primary light path, and also prevents heat generation in each component within the projection display apparatus 100. Also, a cooling means including the fan 14 prevents temperature rise in the absorbing plate 76.

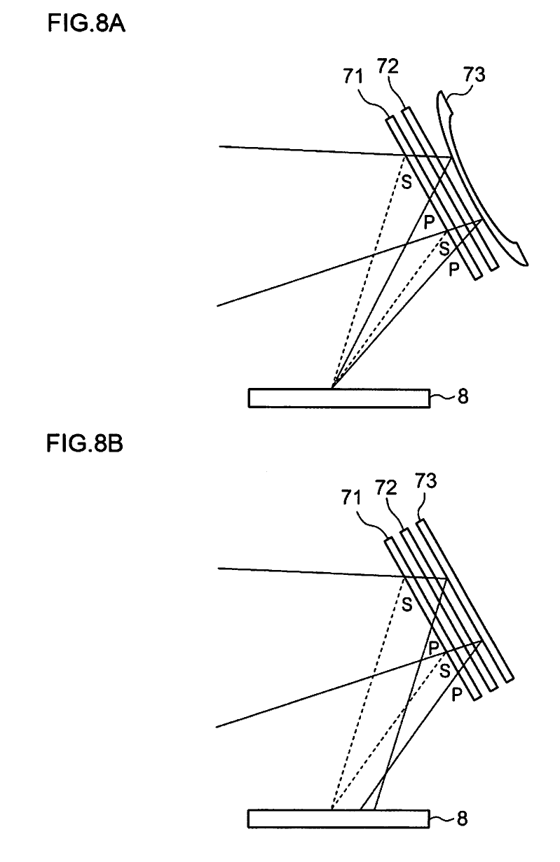

FIG. 8 are diagrams that show configurations of reflecting optical units according to a modification 5 of the embodiment 2: FIG. 8A shows an example in which the second polarization separation element 73 is configured to be a convex while FIG. 8B shows the configuration as shown in FIG. 2. In the above, there have been described configurations in which the first polarization separation element 71, switching element 72, and second polarization separation element 73 are formed as plane plates, and air gaps are provided between the first polarization separation element 71 and switching element 72 and between the switching element 72 and second polarization separation element 73. These configurations are suitable to discharge heat accumulated in each of the first polarization separation element 71, switching element 72, and second polarization separation element 73.

However, in the two-dimensional mode, there is a problem that a difference of the traveling direction of the light beam occurs between S-polarized light reflected by the first polarization separation element 71 toward the imager 8 and P-polarized light reflected by the second polarization separation element 73 toward the imager 8 (see FIG. 8B). In other words, there occurs a difference of the position of illumination area on the imager 8 between both the light beams. Since the part where the illumination areas of both the light beams do not overlap is too dark to be used, only the part where the two illumination areas overlap each other will be used, resulting in the reduction of use efficiency of light.

On the other hand, by configuring the second polarization separation element 73 as a convex as shown in FIG. 8A, the position of the illumination area on the imager 8 of S-polarized light reflected by the first polarization separation element 71 and that of P-polarized light reflected by the second polarization separation element 73 can be substantially matched.

Even when the second polarization separation element 73 is configured as a plane, the focus positions of both the light beams can be brought close to each other to some extent by tilting the second polarization separation element 73 with respect to the first polarization separation element 71. However, since there occurs an optical path difference between S-polarized light reflected by the first polarization separation element 71 and P-polarized light reflected by the second polarization separation element 73, if the optical system is designed so that the S-polarized light is focused on the imager 8, the P-polarized light will not be focused on the imager 8.

In such a case, by placing the imager 8 between the focal position of the S-polarized light and that of the P-polarized light, the light provided on the imager 8 can be homogenized.

As described above, the modification 5 of the embodiment 2 enables both the discharge of heat accumulated in the first polarization separation element 71, switching element 72, and second polarization separation element 73, and the prevention of occurrence of a difference between the focus position of S-polarized light and that of P-polarized light in the two-dimensional mode. More specifically, providing air gaps between the first polarization separation element 71 and switching element 72 and between the switching element 72 and second polarization separation element 73 facilitates the discharge of heat. Also, configuring the second polarization separation element 73 as a convex or tilting the second polarization separation element 73 prevents the occurrence of a difference of the focus position between S-polarized light and P-polarized light in the two-dimensional mode. Even in the case where air gaps are not provided between the first polarization separation element 71 and switching element 72 and between the switching element 72 and second polarization separation element 73, since there occurs an optical path difference of the thickness of the substrate forming each of the elements, the measures stated above are also effective.

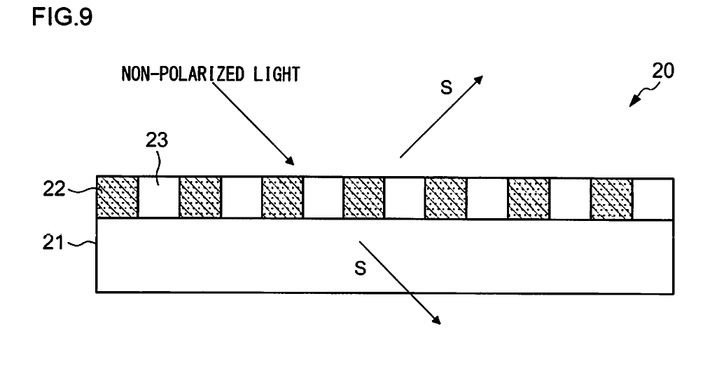

FIG. 9 is a diagram that shows a configuration of an optical element according to an embodiment 3. The optical element according to the embodiment 3 is made based on a conventional wire grid. Multiple metal wires 22 are disposed on a glass substrate 21 with certain gaps between the wires. Each metal wire may be configured with an aluminum rib.

In the embodiment 3, half-wave plates 23 are inserted between the multiple metal wires. Namely, the metal wires 22 and half-wave plates 23 are aligned in stripes. Although a conventional wire grid reflects S-polarized light and transmits P-polarized light included in incident light, the wire grid according to the embodiment 3 (hereinafter, referred to as a λ/2 wire grid 20) reflects S-polarized light and converts P-polarized light in incident light to S-polarized light to transmit the converted light.

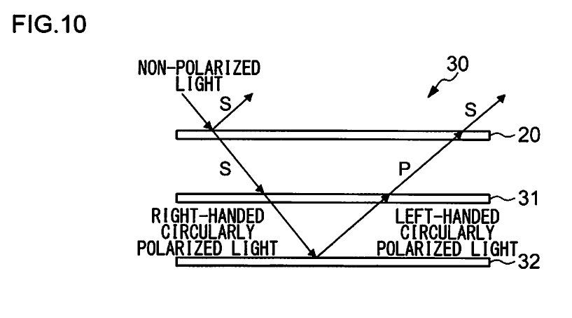

FIG. 10 is a diagram that shows a configuration of an optical unit 30 according to an embodiment 4. The optical unit 30 according to the embodiment 4 includes the λ/2 wire grid 20 according to the embodiment 3. The optical unit 30 according to the embodiment 4 comprises the λ/2 wire grid 20, a quarter-wave plate 31, and a reflecting plate 32. In the optical unit 30, the λ/2 wire grid 20, quarter-wave plate 31, and reflecting plate 32 are placed in this order as viewed from the incident light side. For example, the reflecting plate 32 (configured with a conventional mirror, for example), quarter-wave plate 31, and λ/2 wire grid 20 may be laminated in this order and integrally formed.

The λ/2 wire grid 20 reflects S-polarized light and converts P-polarized light in incident light to S-polarized light to transmit the converted light. The quarter-wave plate 31 converts the S-polarized light, which has been converted and transmitted by the λ/2 wire grid 20, to right-handed circularly polarized light and transmits the converted light. The reflecting plate 32 converts the right-handed circularly polarized light provided from the quarter-wave plate to left-handed circularly polarized light and reflects the converted light. The quarter-wave plate 31 then converts the left-handed circularly polarized light provided from the reflecting plate 32 to P-polarized light and transmits the converted light. Thereafter, the λ/2 wire grid 20 converts the P-polarized light provided from the quarter-wave plate 31 to S-polarized light and transmits the converted light. Thus, the optical unit 30 according to the embodiment 4 can convert every component of non-polarized light incident thereon to S-polarized light.

As stated above, according to the embodiment 4, every component of non-polarized light can be converted to S-polarized light, thereby fixing polarization to a certain direction while preventing the reduction of light amount.

The optical unit 30 according to the embodiment 4 may be employed as the optical unit 7 according to the embodiment 1 or 2. More specifically, the λ/2 wire grid 20, quarter-wave plate 31, and reflecting plate 32 may be used instead of the first polarization separation element 71, switching element 72, and second polarization separation element 73.

With the optical unit 30 according to the embodiment 4, since the light amount does not decrease even in the three-dimensional mode, there is no need to switch the state between the two-dimensional mode and three-dimensional mode. It is because there may be both the non-polarization state and the state in which polarization is fixed to a certain direction in the two-dimensional mode. Since there is no need to switch the state between the two-dimensional mode and three-dimensional mode, electrical control is also unnecessary.

Thus, in addition to the effects of the optical unit according to the embodiment 2, the optical unit 30 according to the embodiment 4 further provides advantageous effects, such that the light amount for each image does not decrease even in the three-dimensional mode and that electrical control is unnecessary and the configuration can be more simplified.

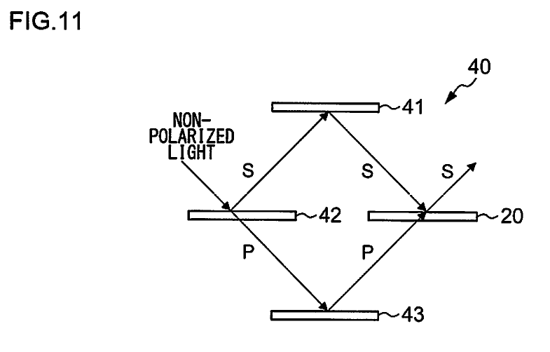

FIG. 11 is a diagram that shows a configuration of an optical unit 40 according to an embodiment 5. The optical unit 40 according to the embodiment 5 also includes the λ/2 wire grid 20 according to the embodiment 3. The optical unit 40 according to the embodiment 5 comprises a first reflecting plate 41, a normal wire grid 42, the λ/2 wire grid 20, and a second reflecting plate 43. In the optical unit 40, the normal wire grid 42, the first reflecting plate 41 and second reflecting plate 43 (these two are in the same ordinal position), and the λ/2 wire grid 20 are placed in this order as viewed from the incident light side.

The normal wire grid 42 reflects S-polarized light and transmits P-polarized light included in incident light. The first reflecting plate 41 then reflects the S-polarized light reflected by the normal wire grid 42. Also, the second reflecting plate 43 reflects the P-polarized light transmitted by the normal wire grid 42. The λ/2 wire grid 20 reflects the S-polarized light provided from the first reflecting plate 41 and also converts the P-polarized light provided form the second reflecting plate 43 to S-polarized light to transmit the converted light. Thus, the optical unit 40 according to the embodiment 5 also can convert every component of non-polarized light incident thereon to S-polarized light.

As described above, the optical unit 40 according to the embodiment 5 provides the same effect as the optical unit 30 according to the embodiment 4.

The present invention has been described with reference to some embodiments. The embodiments are intended to be illustrative only, and it will be obvious to those skilled in the art that various modifications to constituting elements or processes could be developed and that such modifications also fall within the scope of the present invention.

There have been described examples in which the optical unit according to the embodiment 2, 4, or 5 is applied to the projection display apparatus 100. However, such an optical unit is also applicable to a display apparatus of non-projection type, such as a liquid crystal display and an organic EL display.

The optical unit and time-division polarization switching element according to each embodiment exert the effects as described above, as long as they are placed in any positions between a light source and a screen. Also, although the embodiments describe examples using a liquid crystal element that behaves as a half-wave plate using birefringence of liquid crystal, the switching of the polarization direction is also enabled using optical rotation of liquid crystal.

The embodiment 2 describes an example in which the first polarization separation element 71 reflects S-polarized light and the second polarization separation element 73 also reflects S-polarized light. However, the first polarization separation element 71 may be set to reflect P-polarized light while the second polarization separation element 73 is also set to reflect P-polarized light, the first polarization separation element 71 may be set to reflect S-polarized light while the second polarization separation element 73 is set to reflect P-polarized light, or the first polarization separation element 71 may be set to reflect P-polarized light while the second polarization separation element 73 is set to reflect S-polarized light.

In the first setting of the three setting examples cited above, the control unit 10 applies a voltage to the switching element 72 in the three-dimensional mode so as to provide control such that the switching element 72 is placed in the first state set forth above (a simple transmission plate), while the control unit 10 applies no voltage to the switching element 72 in the two-dimensional mode so as to provide control such that the switching element 72 is placed in the second state set forth above (a half-wave plate).

In the second and third settings of the three setting examples cited above, on the other hand, the control unit 10 applies a voltage to the switching element 72 in the two-dimensional mode so as to provide control such that the switching element 72 is placed in the first state set forth above (a simple transmission plate), while the control unit 10 applies no voltage to the switching element 72 in the three-dimensional mode so as to provide control such that the switching element 72 is placed in the second state set forth above (a half-wave plate).

What is claimed is:

1. An optical unit, comprising:
a first polarization separation element and a second polarization separation element which each are configured to reflect one of two polarization components perpendicular to each other included in incident light and transmit the other polarization component; and
a switching element placed between the first polarization separation element and the second polarization separation element and configured to be switchable between a first state of transmitting an incident polarization component as it is and a second state of converting an incident polarization component to the other polarization component perpendicular thereto and transmitting the converted component.

2. A projection display apparatus, comprising:
the optical unit of claim 1; and
a control unit configured to switch between a two-dimensional mode for displaying a two-dimensional image and a three-dimensional mode for displaying a three-dimensional image, the control unit providing control such that the switching element is placed in the first state or the second state in accordance with switching between the two-dimensional mode and the three-dimensional mode.

3. The projection display apparatus of claim 2, further comprising:
a imager configured to modulate light reflected by the optical unit in accordance with an image signal;
a projection lens configured to project light modulated by the imager onto a projection surface; and
a time-division polarization switching element placed between the imager and the projection lens and configured to switch the polarization direction of light modulated by the imager in a time-division manner, wherein
the control unit allows the time-division polarization switching element to switch the polarization direction in a time-division manner in the three-dimensional mode.

4. The projection display apparatus of claim 2, wherein:
the switching element functions as a mode switching element configured to switch between the two-dimensional mode and the three-dimensional mode;
the optical unit further comprises a time-division polarization switching element configured to switch the polarization direction of a polarization component reflected by the first polarization separation element in a time-division manner;
the second polarization separation element, the mode switching element, the first polarization separation element, and the time-division polarization switching element are placed in this order in the optical unit; and
the control unit allows the time-division polarization switching element to switch the polarization direction in a time-division manner in the three-dimensional mode.

5. An optical element of wire grid type including metal wires and half-wave plates inserted between the metal wires.
